(19) United States
(12) Patent Application Publication
(10) Pub. No.: US 2019/0138731 A1
(43) Pub. Date: May 9, 2019

(54) METHOD FOR DETERMINING DEFECTS AND VULNERABILITIES IN SOFTWARE CODE

(71) Applicants: Lin TAN, Waterloo (CA); Song WANG, Kitchener (CA); Jaechang NAM, Kitchener (CA)

(72) Inventors: Lin TAN, Waterloo (CA); Song WANG, Kitchener (CA); Jaechang NAM, Kitchener (CA)

(21) Appl. No.: 16/095,400

(22) PCT Filed: Apr. 21, 2017
(86) PCT No.: PCT/CA2017/050493

§ 371 Date: Oct. 22, 2018

Related U.S. Application Data
(60) Provisional application No. 62/391,166, filed on Apr. 22, 2016.

(51) Int. Cl. G06F 21/57; G06F 11/36; G06F 11/34; G06N 3/02; G06N 7/00; G06K 9/62

(52) U.S. Cl. CPC G06F 21/577; G06F 11/3608; G06F 11/3612; G06F 11/3466; G06F 2201/865; G06N 7/005; G06K 9/6256; G06F 2221/033; G06N 3/02

(57) ABSTRACT

The disclosure is directed at a method for determining defects and security vulnerabilities in software code. The method includes generating a deep belief network (DBN) based on a set of training code produced by a programmer and evaluating performance of the DBN against a set of test code against the DBN.

### CROSS-REFERENCE TO OTHER APPLICATIONS

This application claims the benefit of U.S. Patent Application No. 62/391,166, filed Apr. 22, 2016, which is hereby incorporated by reference.

### FIELD OF THE DISCLOSURE

The current disclosure is directed at finding defects and vulnerabilities and more specifically, at a method for determining defects and security vulnerabilities in software code.

### BACKGROUND OF THE DISCLOSURE

As technology continues to evolve, software development remains at the forefront of this evolution. However, the desire to attack the software is also on the rise. In order to protect the software from attack, software testing is performed on a regular basis during the development timeline in order to find bugs, software vulnerabilities and the like. The testing and quality assurance review of any software development is not new. Testing has been performed as long as software has been development, however, there still exists flaws within developed software.

In some current solutions, different software code regions having different semantics cannot be distinguished. For instance, some code regions within software program files have traditional features with the same values and therefore, feature vectors generated by these features are identical and there is no way to distinguish the semantic differences.

Software vulnerabilities can be seen as a special kind of defects. Depending on the application, they can be more important than bugs and require a quite different identification process than defects. There are also many more bugs than vulnerabilities (at least many more bugs are reported every year). Furthermore, vulnerabilities are critical, while some bugs are not so that they are never fixed. Finally, most developers have a better understanding of how to identify and deal with defects than with vulnerabilities.

Thus, discovering vulnerabilities is a hard and costly procedure. To support this process, researchers have developed machine learning based vulnerability prediction models based on software metrics, text mining, and function calls. Unfortunately, previous studies do not make reliable and effective prediction for software security vulnerabilities. In this method, we propose to use deep learning to generate new semantic features to help build more accuracy security vulnerability prediction models.

Therefore, there is provided a novel method for determining defects and security vulnerabilities in software code.

### SUMMARY OF THE DISCLOSURE

The disclosure is directed at a method for determining defects and security vulnerabilities in software code. The method includes generating a deep belief network (DBN) based on a set of training code produced by a programmer and evaluating performance of the DBN against a set of test code against the DBN.

In one aspect of the disclosure, there is provided a method of identifying software defects and vulnerabilities including generating a deep belief network (DBN) based on a set of training code produced by a programmer; and evaluating performance of a set of test code by against the DBN.

In another aspect, generating a DBN includes obtaining tokens from the set of training code; and building a DBN based on the tokens from the set of training code. In an alternative aspect, building a DBN further includes building a mapping between integer vectors and the tokens; converting token vectors from the set of training code into training code integer vectors; and implementing the DBN via the training code integer vectors.

In another aspect, evaluating performance includes generating semantic features using the training code integer vectors; building prediction models from the set of training code; and evaluating performance of the set of test code versus the semantic features and the prediction models.

In a further aspect, obtaining tokens includes extracting syntactic information from the set of training code. In yet another aspect, extracting syntactic information includes extracting Abstract Syntax Tree (AST) nodes from the set of training code as tokens. In yet a further aspect, generating a DBN includes training the DBN. In an aspect, training the DBN includes setting a number of nodes to be equal in each layer; reconstructing the set of training code; and normalizing data vectors. In a further aspect, before setting the nodes, training a set of pre-determined parameters. In an alternative aspect, one of the parameters is number of nodes in a hidden layer.

In yet another aspect, mapping between integer vectors and the tokens includes performing an edit distance function; removing data with incorrect labels; filtering out infrequent nodes; and collecting bug changes. In another aspect, a report of the software defects and vulnerabilities is displayed.

### DESCRIPTION OF THE DRAWINGS

Embodiments of the present disclosure will now be described, by way of example, only, with reference to the attached Figures.

FIG. 1 is a flowchart outlining a method of determining defects and security vulnerabilities in software code;

FIG. 2 is a flowchart outlining a method of developing a deep belief network (DBN) for the method of FIG. 1;

FIG. 3 is a flowchart outlining a method of obtaining token vectors;

FIG. 4 is a flowchart outlining one embodiment of mapping between integers and tokens;

FIG. 5 is a flowchart outlining a method of mapping tokens;

FIG. 6 is a flowchart outlining a method of training a DBN;

FIG. 7 is a flowchart outlining a further method of generating defect predictions models;

FIG. 8 is a flowchart outlining a method of generating prediction models

FIG. 9 is a schematic diagram of another embodiment of determining bugs in software code;

FIG. 10 is a schematic diagram of a DBN architecture;

FIG. 11 is a schematic diagram of a defect prediction process;

FIG. 12 is a table outlining projects evaluated for file-level defect prediction;

FIG. 13 is a table outlining projects evaluated for change-level defect prediction;

FIG. 14 is a chart outlining average F1 scores for tuning the number of hidden layers and the number of nodes in each hidden layer;

FIG. 15 is a chart showing that number of iterations vs error rate; and

FIG. 16 is a schematic diagram of an explanation checker framework.

### DETAILED DESCRIPTION OF THE EMBODIMENTS

The disclosure is directed at a method for determining defects and security vulnerabilities in software code. The method includes generating a deep belief network (DBN) based on a set of training code produced by a programmer and evaluating a set of test code against the DBN. The set of test code can be seen as programming code produced by the programmer that needs to be evaluated for defects and vulnerabilities. In one embodiment, the set of test code is evaluated using a model trained by semantic features learned from the DBN.

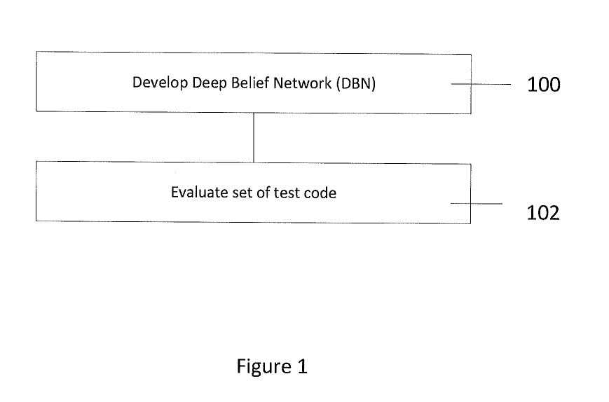

Turning to FIG. 1, a method of identifying software defects and vulnerabilities of an individual programmer's source, or software, code is provided. In the description below, the term “bugs” will be used to describe software defects and vulnerabilities. Initially, a deep belief network (DBN) is developed (100), or generated, based on a set of training code which is produced by a programmer. This set of training code can be seen as source code which has been previously created or generated by the programmer. The set of training code may include source code at different times during a software development timeline or process whereby the source code includes errors or bugs.

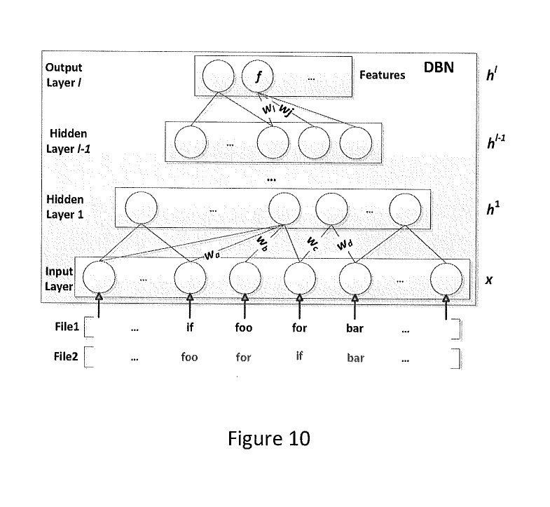

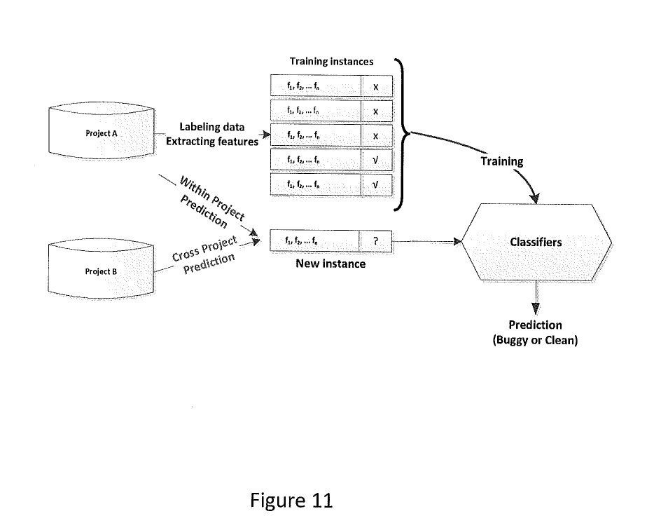

As will be understood, a DBN can be seen as a generative graphical model that uses a multi-level neural network to learn a representation from the set of training code that could reconstruct the semantic and content of any further input data (such as a set of test code) with a high probability. In a preferred embodiment, the DBN contains one input layer and several hidden layers, and the top layer is the output layer that used as features to represent input data such as schematically shown in FIG. 10. Each layer preferably includes a plurality or several stochastic nodes. The number of hidden layers and the number of nodes in each layer vary depending on the programmer's demand. In a preferred embodiment, the size of learned semantic features is the number of nodes in the top layer whereby the DBN enables the network to reconstruct the input data using generated features by adjusting weights between nodes in different layers.

In one embodiment, the DBN models the joint distribution between input layer and the hidden layers as follows:

P(x,h¹, . . . h¹)=P(x|h¹)(Πₖ₌₁^{l}P(h^{k}|h⁺¹)) Equation (1)

where x is the data vector from input layer, I is the number of hidden layers, and h^{k} is the data vector of k^{th} layer (1<k<1). P(h^{k}|h^{k+1}) is a conditional distribution for the adjacent k and k+1 layer.

To calculate P(h^{k}|h^{k+1}), each pair of two adjacent layers in the DBN are trained as Restricted Boltzmann Machines (RBM). An RBM is a two-layer, undirected, bipartite graphical model where the first layer includes observed data variables, referred to as visible nodes, and the second layer includes latent variables, referred to as hidden nodes. P(h^{k}|h^{k+1}) can be efficiently calculated as:

P(h^{k}|h^{k+1})=Πⱼ₌₁ⁿ^{ₖ}P(hⱼ^{k}|h^{k+1}) Equation (2)

P(hⱼ^{k}=1|^{k+1})=sigm(bⱼ^{k}+Σₐ₌₁ⁿ^{ₖ₊₁}Wₐⱼ^{k}hₐ^{k+1}) Equation (3)

where nₖ is the number of node in layer k, sigm(c)=)1/(1+e^{-c}), b is a bias matrix, b^{k}ⱼ is the bias for node j of layer k, and W^{k} is the weight matrix between layer k and k+1.

The DBN automatically learns the W and b matrices using an iteration or iterative process where W and b are updated via log-likelihood stochastic gradient descent:

$$\begin{matrix}{W}_{ij} ( t + 1 ) = {W}_{ij} ( t ) + η \frac{\partial log ( P ( v \vert h ) )}{\partial {W}_{ij}} & Equation ( 4 ) \\ {b}_{k}^{o} ( t + 1 ) = {b}_{k}^{o} ( t ) + η \frac{\partial log ( P ( v \vert h ) )}{\partial {b}_{k}^{o}} & Equation ( 5 )\end{matrix}$$

where t is the t^{th} iteration, η is the learning rate, P(v|h) is the probability of the visible layer of an RBM given the hidden layer, i and j are two nodes in different layers of the RBM, Wᵢⱼ is the weight between the two nodes, and b^{o}ₖ is the bias on the node o in layer k.

To train the network, one first initializes all W matrices between two layers via RBM and sets the biases b to 0. These can be tuned with respect to a specific criterion, e.g., the number of training iterations, error rate between reconstructed input data and original input data. In one embodiment, the number of training iterations may be used as the criterion for tuning W and b. The well-tuned W and b are used to set up the DBN for generating semantic features for both the set of training code and a set of test code, or data.

After the DBN has been developed, a set of test code (produced by the same programmer) can be evaluated (102) with respect to the DBN. Since the DBN is developed based on the programmer's own set of training code, the DBN may more easily or quickly identify possible defects or vulnerabilities in the programmer's set of test code.

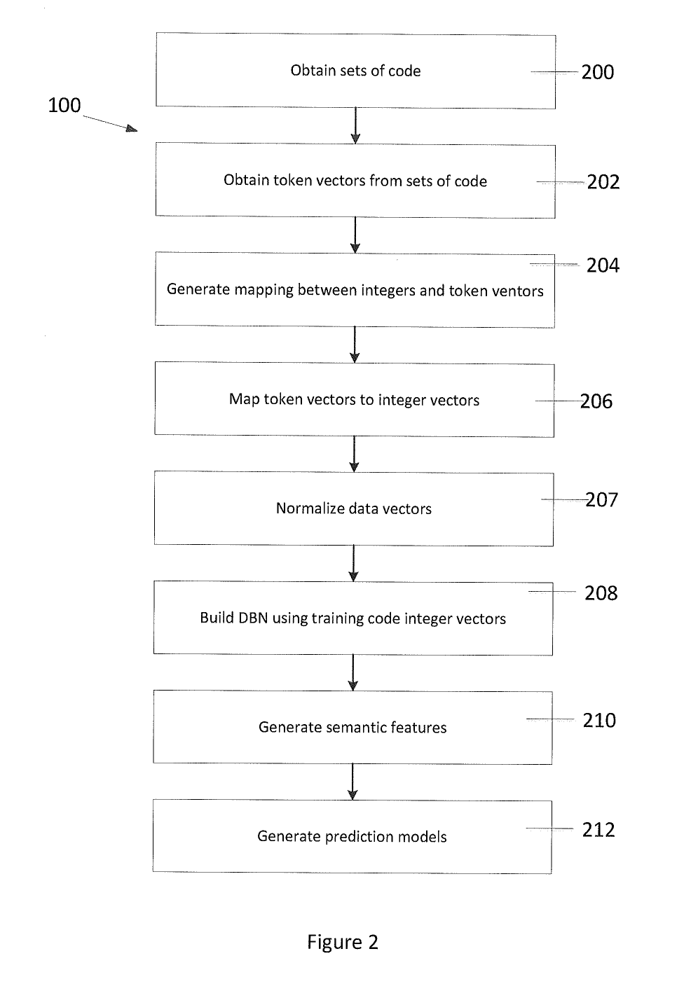

Turning to FIG. 2, another method of developing a DBN is shown. The development of the DBN (100) initially requires obtaining a set of training code (200). Simultaneously, if available, a set of test code may also be obtained, however the set of test code is for evaluation purposes. As outlined above, the set of training code represents code that the programmer has previously created (including bugs and the like) while the set of test code is the code which is to be evaluated for software defects and vulnerabilities. The set of test code may also be used to perform testing with respect to the accuracy of the generated DBN.

Initially, token vectors from the set of training code and, if available, the set of test code are obtained (202). As will be understood, tokenization is the process of substituting a sensitive data element with a non-sensitive data equivalent. In one embodiment, the tokens are code elements that are identified by a compiler and are typically the smallest element of program code that is meaningful to the compiler. These token vectors may be seen as training code token vectors and test code token vectors, respectively. A mapping between integers and tokens, or token vectors, is then generated (204) for both the set of training code and the set of test code, if necessary. As will be understood the functions or processes being performed on the set of test code are to prepare the code for testing and do not serve as part of the process to develop the DBN. Both sets of token vectors are then mapped to integer vectors (206) which can be seen as training code integer vectors and test code integer vectors. The data vectors are then normalized (207). The training code integer vectors are then used to build the DBN (208) by using the training code integer vectors to train the settings of the DBN model i.e., the number of layers, the number of nodes in each layer, and the number of iterations. The DBN can then generate semantic features (210) from the training code integer vectors and the test set integer vectors. After training the DBN, all settings are fixed and the training code integer vectors and the test set integer vectors inputted into the DBN model. The semantic features for both the training and test sets can then be obtained from the output of the DBN. Based on these sematic features, defect prediction models are created (212) from the set of training code against which performance can be evaluated against the set of test code for accuracy testing. The developed DBN can then be used to determine the bugs (as outlined in FIG. 1).

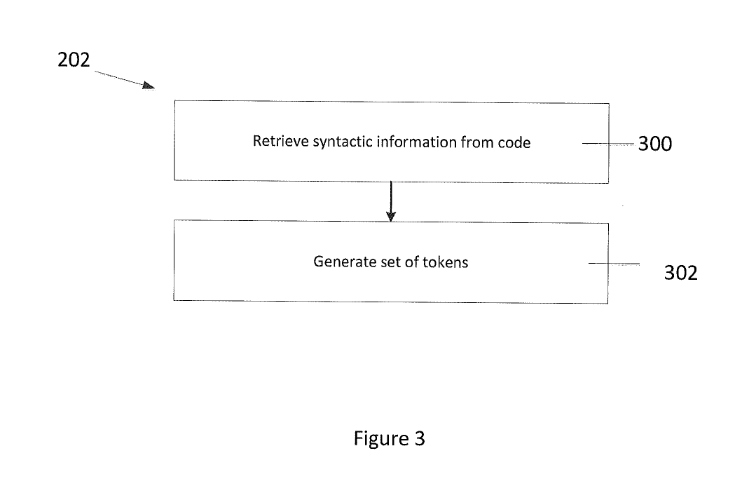

Turning to FIG. 3, a flowchart outlining one embodiment of obtaining token vectors (202) from a set of training code and, if available, a set of test code is shown. Initially, syntactic information is retrieved from the set of training code (300) and the set of tokens, or token vectors, generated (302). In one example, Java Abstract Syntax Tree (AST) can be used. In this example, three types of AST nodes can be extracted as tokens. One type of node is method invocations and class instance creations that can be recorded as method names. A second type of node is declaration nodes i.e. method declarations, type declarations and/or enum declarations and the third type of node is control flow nodes such as while statements, catch clauses, if statements, throw statements and the like. In a preferred embodiment, control flow nodes are recorded as their statement types e.g. an if statement is simply recorded as “if”. Therefore, in a preferred embodiment, for each set of training code, or file, a set of token vectors is generated in these three categories. In a further embodiment, use of other AST nodes, such as assignment and intrinsic type declarations, may also be contemplated and used.

In some cases, a programmer may be working on different projects whereby it may be beneficial to use the method and system of the disclosure to examine the programmer's code. In order to protect against cross-project defect prediction, for AST nodes for the method invocation and the declaration type nodes, instead of using the name, the node types such as, but not limited to, method declarations and method invocations are used for labelling purposes.

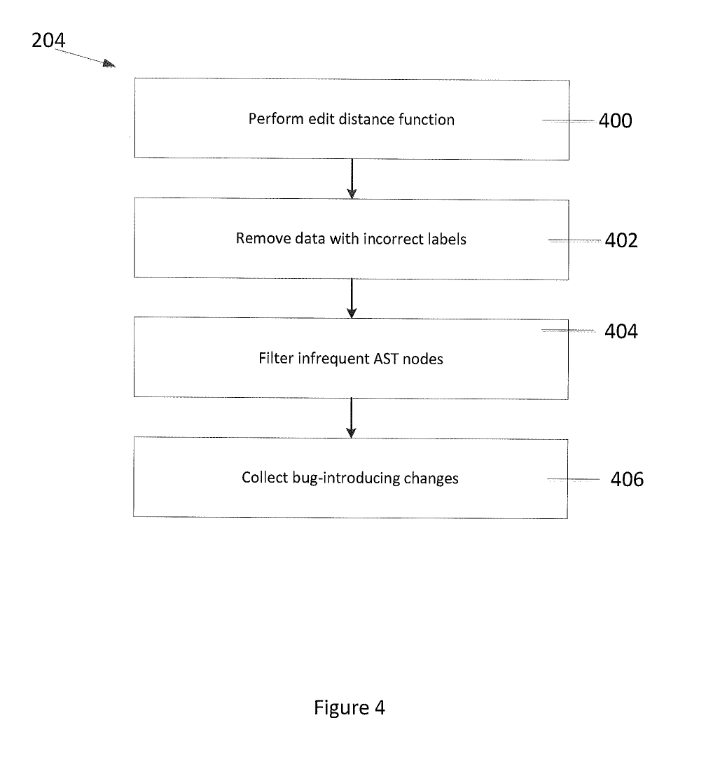

Turning to FIG. 4, a flowchart outlining one embodiment of mapping between integers and tokens, and vice-versa, (206) is shown. In order to improve the mapping, the “noise” within the set of training code should to be reduced. In this case, the “noise” may be seen as the defect data or from a mislabelling. In a preferred embodiment, to reduce or eliminate mislabelling data, an edit distance function is performed (400). An edit distance function may be seen as a similarity computation algorithm that is used to define the distances between instances. The edit distances are sensitive to both the tokens and order among the tokens. Given two token sequences A and B, the edit distance d(A,B) is the minimum-weight series of edit operations that transform A to B. The smaller d(A,B) is, the more similar A and B are. Based on the edit distance measurements, the data with incorrect labels can then be removed or eliminated (402). For instance, the criteria for removal may be those with distances above a specific threshold although other criteria may be contemplated. In one embodiment, this can be performed using an algorithm such as, but not limited to, closest list noise identification (CLNI). Depending on the goals of the system, the CLNI can be tuned as per the parameters of the vulnerabilities discovery.

Infrequent AST nodes can then be filtered out (404). These AST nodes may be ones that are designed for a specific file within the set of training code and cannot be generalized to other files within the set of training code. In one embodiment, if the number of occurrences of a token is less than three, the node (or token) is filtered out. In other words, the node used less than a predetermined threshold.

If change-level defect prediction is being performed, bug-introducing changes can be collected (406). In one embodiment, this can be performed by an improved SZZ algorithm. These improvements include, but are not limited to, at least one of filtering out test cases, git blame in the previous commit of a fix commit, code omission tracking and text/cosmetic change tracking. As is understood, git is an open source version control system (VCS) for tracking changes in computer files and coordinating work on these files among multiple people.

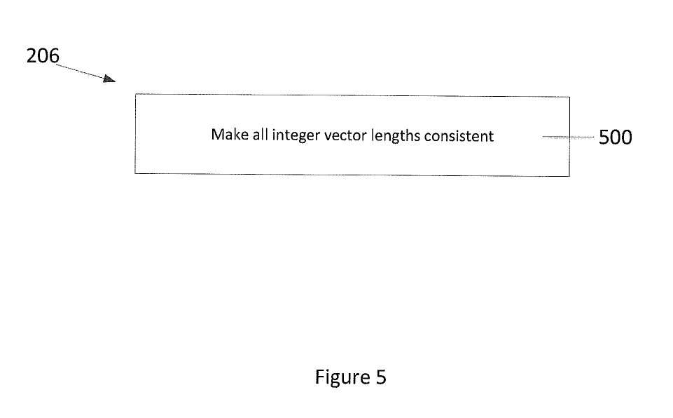

Turning to FIG. 5, a flowchart outlining a method of mapping tokens (206) is shown. As the DBN generally only takes numerical vectors as inputs, the lengths of the input vectors should be the same. Each token has a unique integer identifier while different method names and class names are different tokens. However, if integer vectors have different lengths, at least one zero is appended to the integer vector (500) to make all the lengths consistent and equal in length to the longest vector. As will be understood, adding zeroes does not affect the results and is used as a representation transformation and make the vectors acceptable by the DBN. For example, turning to FIG. 10, considering File1 and File 2, the token vectors for File1 and File2 are mapped [1, 2, 3, 4] and [2, 3, 1, 4] respectively. Through this mapping, or encoding process, method invocation information and inter-class information are represented as integer vectors. In addition, some program structure information is preserved since the order of tokens remains unchanged.

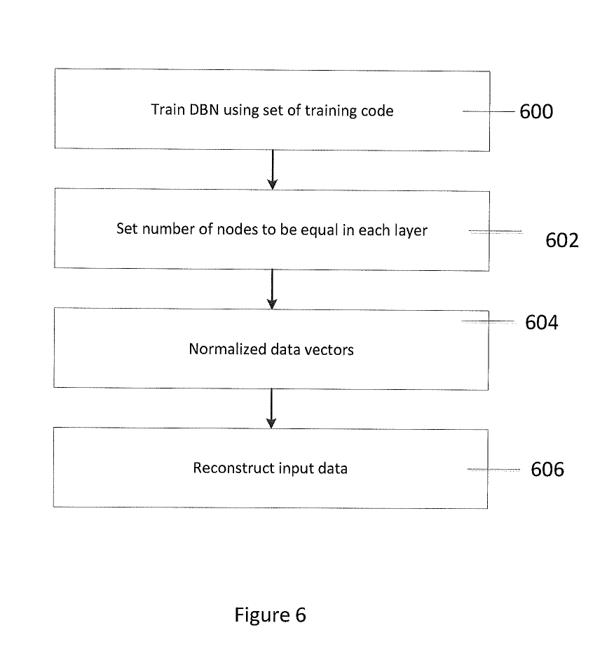

Turning to FIG. 6, a flowchart outlining a method of training a DBN is shown. Initially, the DBN is trained and/or generated by the set of training code (600). In one embodiment of training, a set of parameters may be trained. In the preferred embodiment, three parameters are trained. These parameters may be the number of hidden layers, the number of nodes in each hidden layer and the number of training iterations. By tuning these parameters, improvements in detecting bugs may be appreciated.

In a preferred embodiment, the number of nodes is set to be the same in each layer (602). Through the hidden layers and nodes, the DBM obtains characteristics that may be difficult to be observed but may be used to capture semantic differences. For instance, for each node, the DBN may learn the probabilities of traversing from the node to other nodes of its top level.

Since the DBN requires values of input data ranging from 0 to 1 while the data in the input vectors can have any integer values, in order to satisfy this requirement, the values in the data vectors in the set of training code and the set of test code are normalized (604). In one embodiment, this may be performed using a min-max normalization. Since integer values for different tokens are identifiers, one token with a mapping value of 1 and one token with a mapping value of 2 represents that these two nodes are different and independent. Thus, the normalized values can still be used as a token identifier since the same identifiers still keep the same normalized values. Through back-propagating validation, the DBN can reconstruct the input data using generated features by adjusting weights between nodes in different layers (606).

Different from labelling file-level defect data, labelling change-level defect data requires a further link between bug-fixing changes and bug-introducing changes. A line that is deleted or changed by a bug-fixing change is a faulty line, and the most recent change that introduced the faulty line is considered a bug-introducing change. The bug-introducing changes can be identified by a blame technique provided by a VCS, e.g., git or SZZ algorithm.

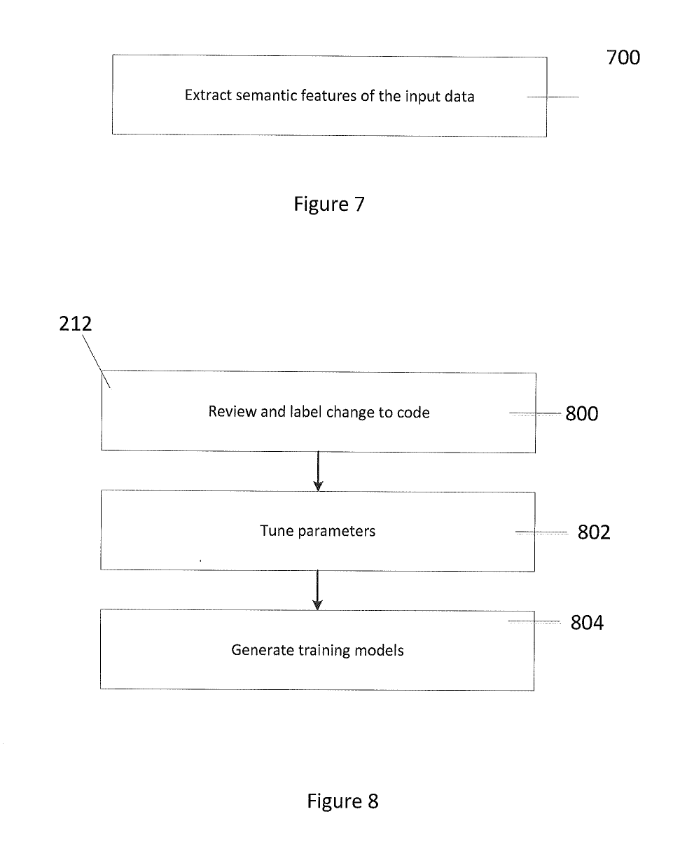

Turning to FIG. 7, a flowchart outlining a further method of generating defect predictions models is shown. The current embodiment may be seen as a software security vulnerability prediction. Similar to file-level and change-level defect prediction, the process of security vulnerability prediction includes a feature extracting process (700). In 700, the method extracts semantic features to represent the buggy or clean instances

Turning to FIG. 8, a flowchart outlining a method of generating a prediction model is shown. Initially, the input data (or an individual file within a set of test code) being used is reviewed and determined to be either buggy or clean (800). This is preferably based on post-release defects for each file. In one embodiment, the defects may be collected from a bug tracking system (BTS) via linking bug reports to its bug-fixing changes. Any file related to these bug-fixing changes can be labelled as being buggy. Otherwise, the file can be labelled as being clean.

The parameters against which the code is to be tested can then be tuned (802). This process is disclosed in more detail below. Finally, the prediction model can be trained and then generated (804).

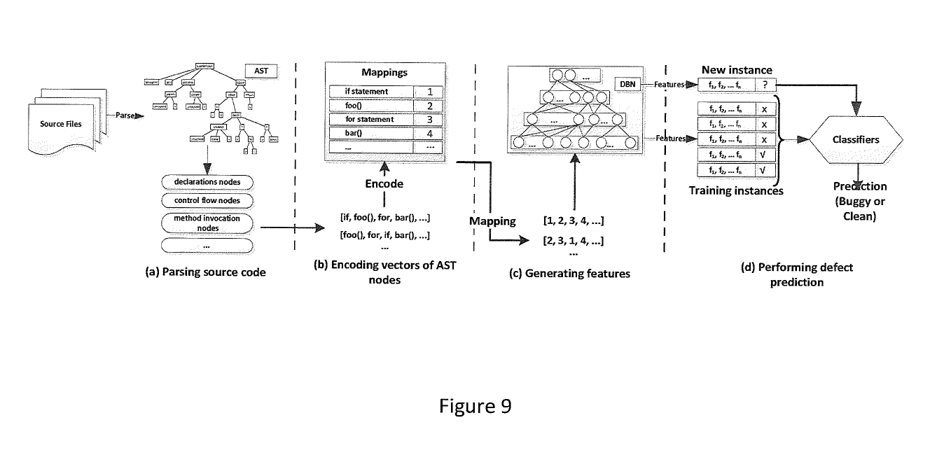

Turning to FIG. 9, a schematic diagram of another embodiment of determining bugs in software code is shown. As shown, initially, source files (or a set of training code) are parsed to obtain tokens. Using these tokens, vectors of AST nodes are then encoded. Semantic features are then generated based on the tokens and then defect prediction can be performed.

Experiments to study the method of the disclosure were also performed. In these experiments, in order to evaluate the effectiveness of the method of the disclosure, both non-effort-aware and effort-aware evaluation scenarios were used.

For non-effort-aware evaluation, three parameters were used. These parameters, or metrics were precision, recall, and F1. F1 is the harmonic mean of the precision and recall to measure prediction performance of models. As understood, F1 is a widely-used evaluation metric. These three metrics are widely adopted to evaluate defect prediction techniques and their processes known. For effort-aware evaluation, two metrics were employed, namely N of B20 and P of B20. These are previously disclosed in an article entitled Personalized Defect Prediction, authored by Tian Jiang, Lin Tan and Sunghun Kim, A S E 2013, Palo Alto, USA.

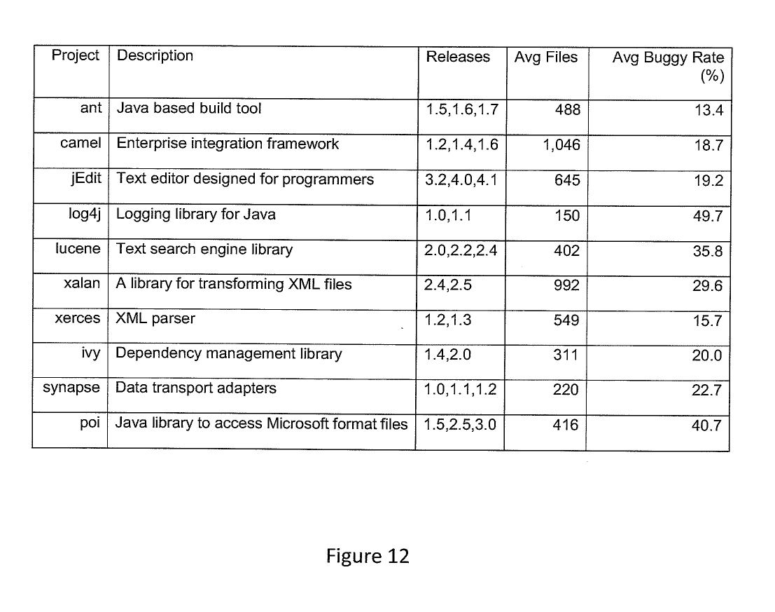

In order to facilitate replication and verification of the experiments for file-level defect prediction, publicly available input data or code was used. In the current experiment, data from the PROMISE data repository was used. All Java open source projects from this data repository were used along with specific version numbers as version numbers are needed to extract token vectors from ASTs of the input data, seen as source code or a set of training code, to feed the method of the disclosure. In total, 10 Java projects were collected. The table shown in FIG. 12 shows the versions, the average number of files, and the average buggy rate of each project. The numbers of files within each project ranged from 150 to 1,046, and the buggy rates of the projects have a minimum value of 13.4% and a maximum value of 49.7%.

The baselines for evaluating the file-level defect prediction semantic features with two different traditional features were compared. The first baseline of traditional features included 20 traditional features, including lines of code, operand and operator counts, number of methods in a class, the position of a class in inheritance tree, and McCabe complexity measures, etc. For the second baseline, the AST nodes that were given to the DBN models i.e. the AST nodes in the input data, after the noise was fixed. Each instance, or AST node, was represented as a vector of term frequencies of the AST nodes.

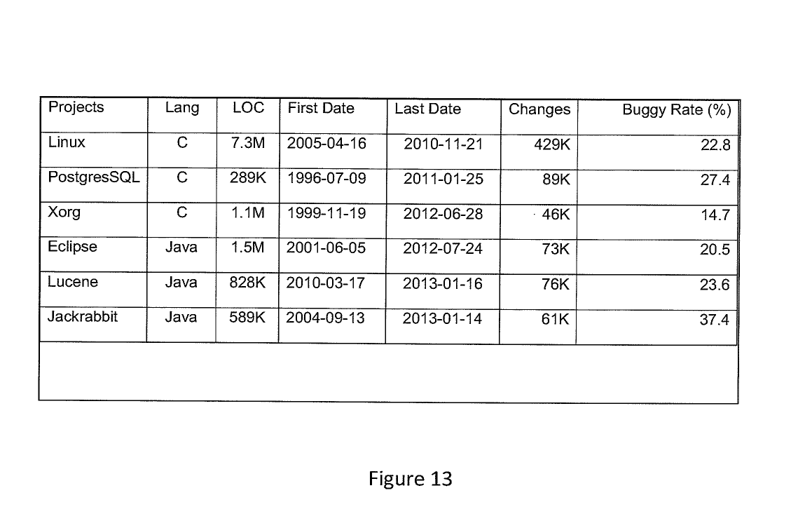

In order to facilitate replication and verification of the experiments for change-level defect prediction, more than 700,000 changes from six open source projects were collected to evaluate the change-level defect prediction with details shown in the table of FIG. 13.

As outlined above, the method of the disclosure includes the tuning of parameters in order to improve the detection of bugs. In one embodiment, the parameters being tuned may include the number of hidden layers, the number of nodes in each hidden layer, and the number of iterations. The three parameters were tuned by conducting experiments with different values of the parameters on ant (1.5, 1.6), camel (1.2, 1.4), jEdit (4.0, 4.1), lucene (2.0, 2.2), and poi (1.5, 2.5) respectively. Each experiment had specific values of the three parameters and ran on the five projects individually. Given an experiment, for each project, an older version of the training code was used to train a DBN with respect to the specific values of the three parameters. Then, the trained DBN was used to generate semantic features for both the older and newer versions. After that, an older version of the training code was used to build a defect prediction model and apply it to the newer version. Lastly, the specific values of the parameters were evaluated by the average F1 score of the five projects in defect prediction.

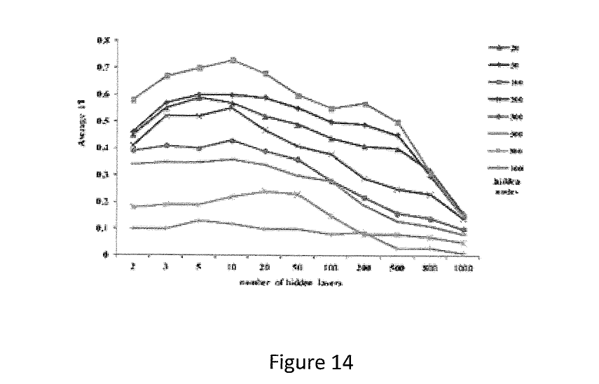

More specifically, in order to set the number of hidden layers and the number of nodes in each layer, since the number of hidden layers and the number of nodes in each hidden layer interact with each other, these two parameters were tuned together. For the number of hidden layers, the experiment was performed with 11 discrete values include 2, 3, 5, 10, 20, 50, 100, 200, 500, 800, and 1,000. For the number of nodes in each hidden layer, eight discrete values including 20, 50, 100, 200, 300, 500, 800, and 1,000 were experimented. When these two parameters were evaluated, the number of iterations was set to 50 and kept constant. FIG. 14 provides a chart outlining average F1 scores for tuning the number of hidden layers and the number of nodes in each hidden layer. When the number of nodes in each layer is fixed, with increasing number of hidden layers, all the average F1 scores are convex curves. Most curves peak at the point where the number of hidden layers is equal to 10. If the number of hidden layers remains unchanged, the best F1 score happens when the number of nodes in each layer is 100 (the top line in FIG. 14). As a result, the number of hidden layers was chosen as 10 and the number of nodes in each hidden layer as 100. Thus, the number of DBN-based features for each project is 100.

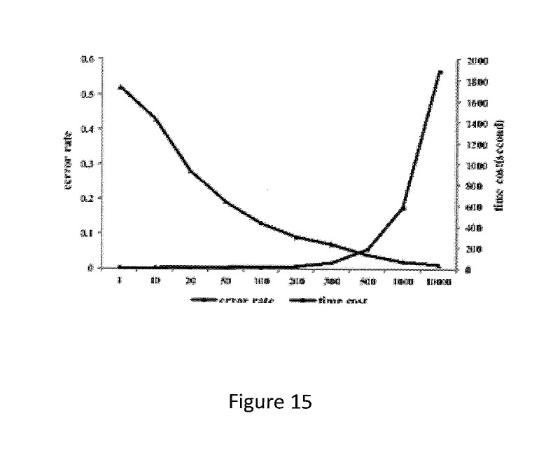

In setting the number of iterations, during the training process, the DBN adjusts weights to narrow down error rate between reconstructed input data and original input data in each iteration. In general, the bigger the number of iterations, the lower the error rate. However, there is a trade-off between the number of iterations and the time cost. To balance the number of iterations and the time cost, the same five projects were selected to the conduct experiments with ten discrete values for the number of iterations. The values ranged from 1 to 10,000 and the error rate was used to evaluate this parameter. This is shown in FIG. 15 which is a chart showing that as the number of iterations increases, the error rate decreases slowly with the corresponding time cost increases exponentially. In the experiment, the number of iterations was set to 200, with which the average error rate was about 0.098 and the time cost about 15 seconds.

In order to examine the performance of the semantic features in the within-project defect prediction, defect prediction models using different machine learning classifiers were used including, but not limited to, ADTree, Naive Bayes, and Logistic Regression. To obtain the set of training code and the set of test code, or data, two consecutive versions of each project listed in FIG. 12 were used. The source code of the older version was used to train the DBN and generate the training data. The trained DBN was then used to generate features for the newer version of the code or test data. For a fair comparison, the same classifiers were used on these traditional features. As defect data is often imbalanced, which might affect the accuracy of defect prediction. The chart in FIG. 12 shows that most of the examined projects have buggy rates less than 50% and so are imbalanced. To obtain optimal defect prediction models, a re-sampling technique such as SMOTE was performed on the training data for both semantic features and traditional features.

The baselines for evaluating change-level defect prediction also included two different baselines. The first baseline included three types of change features, i.e. meta feature, bag-of-words, and characteristic vectors such as disclosed in an article entitled Personalized Defect Prediction, authored by Tian Jiang, Lin Tan and Sunghun Kim, A S E 2013, Palo Alto, USA. More specifically, the meta feature set includes basic information of changes, e.g., commit time, file name, developers, etc. Commit time is the time when developer are committing the modified code into git. It also contains code change metrics, e.g., the added line count per change, the deleted line count per change, etc. The bag-of-words feature set is a vector of the count of occurrences of each word in the text of changes. A snowBall stemmer was used to group words of the same root, then we use Weka to obtain the bag-of-words features from both the commit messages and the source code. The characteristic vectors consider the count of the node type in the Abstract Syntax Tree (AST) representation of code. Deckard was used to obtain the characteristic vector features.

For cross-project defect prediction, due to the lack of defect data, it is often difficult to build accurate prediction models for new projects so cross-project defect prediction techniques are used to train prediction models by using data from mature projects or called source projects, and use the trained models to predict defects for new projects or called target projects. However, since the features of source projects and target projects often have different distributions, making an accurate and precise cross-project defect prediction is still challenging.

The method and system of the disclosure captures the common characteristics of defects, which implies that the semantic features trained from a project can be used to predict bugs within a different project, and is applicable in cross-project defect prediction. To measure the performance of the semantic features in cross-project defect prediction, a technique called DBN Cross-Project Defect Prediction (DBN-CP) can be used. Given a source project (or source code from a set of training code) and a target project (or source code from a set of test code), DBN-CP first trains a DBN by using the source project and generates semantic features for the two projects. Then, DBN-CP trains an ADTree based defect prediction model using data from the source project, and then use the built model to perform defect prediction on the target project. In the current experiment, TCA+ was chosen as the baseline. In order to compare with TCA+, 1 or 2 versions from each project were randomly picked. In total, 11 target projects, and for each target project, we randomly select 2 source projects that are different from the target projects were selected and therefore 22 test pairs collected. TCA+ was selected as it has a high performance in cross-project defect prediction.

In the current production of the TCA+ system, the five normalization methods are implemented and assigned with the same conditions as given in TCA+. A transfer component analysis is then performed on source projects and target projects together, and mapped onto the same subspace while reducing or minimizing data difference and increasing or maximizing data variance. The source projects and target projects were then used to build and evaluate ADTree-based prediction models.

For change-level defect prediction, the performance of the DBN-based features were compared to three types of traditional features. For a fair comparison, the typical time-sensitive experiment process was followed using an ADTree in Weka as the classification algorithm. Through the experiments, it was found that the method of the disclosure was effective in automatically learning semantic features which improves the performance of within-project defect prediction. It was also found that the semantic features automatically learned from DBN improve within-project defect prediction and that the improvement was not connected to a particular classification algorithm. It was also found that the method of the disclosure improved the performance of cross-project defect prediction and that the semantic features learned by the DBN were effective and able to capture the common characteristics of defects across projects.

In another embodiment, given input data such as a source code file, a commit, or a change, if the input data is declared buggy (i.e. contains software bugs or security vulnerabilities), the method of the disclosure may further scan the source code of this predicted buggy instance for common software bug and vulnerability patterns. In its declaration, a check is performed to determine the location of the predicted bugs within the code and the reason why they are considered bugs.

To assist programmers, the system of the disclosure may provide an explanation generation framework that groups and encodes existing bug patters into different checkers and further uses these checkers to capture all possible buggy code spots in the source or test code. A checker is an implementation of a bug pattern or several similar bug patterns. Any checker that defects violations in the predicted bugger instance can be used for generating an explanation.

These may typically fall under two definitions. Definition 1: Bug Pattern A bug pattern describes a type of code idioms or software behaviors that are likely to be errors, and Definition 2: Explanation Checker An explanation checker is an implementation of a bug pattern or a set of similar bug patterns, which could be used to detect instances of the bug patterns involved.

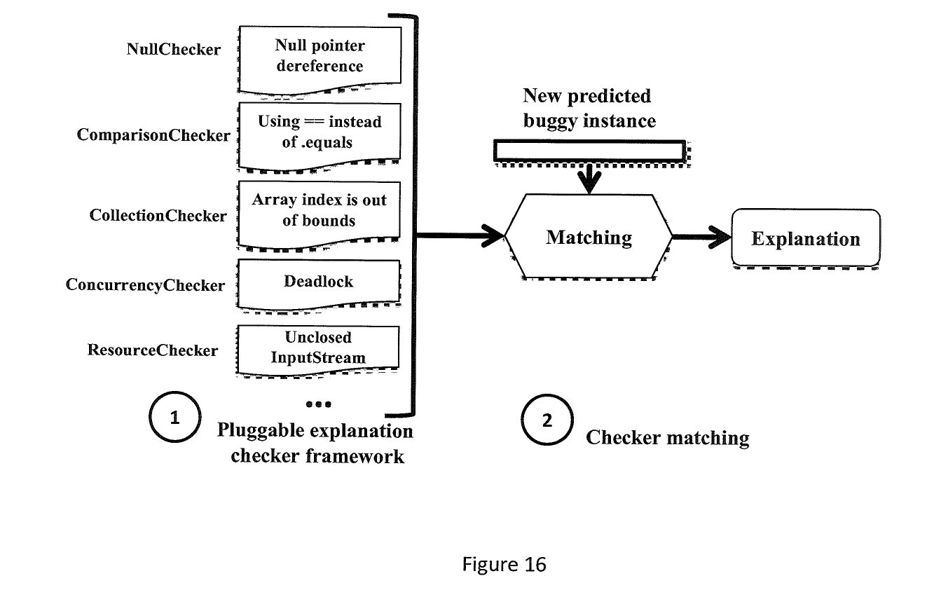

FIG. 16 shows the details of an explanation generation process or framework. The framework includes two components: 1) a pluggable explanation checker framework and 2) a checker-matching process.

The pluggable explanation checker framework includes a set of checkers selected to match the predicted buggy instances. Typically, an existing common bug pattern set contains more than 200 different patterns to detect different types of software bugs. In the current embodiment, the pluggable explanation checker framework includes a core set of five checkers (i.e., NullChecker, ComparisonChecker, CollectionChecker, ConcurrencyChecker, and ResourceChecker) that cover more than 50% of the existing common bug patterns to generate explanations. As will be understood, the checker framework may include any number of checkers.

In use, the NullChecker preferably contains a list of bug patterns for detecting null point exception bugs, e.g., if the return value from a method is null, and the return value of this method is used as an argument of another method call that does not accept null as input. This may lead to a Null-PointerException when the code is executed.

The ComparisonChecker contains a list of bug patterns for detecting bugs occurred during the comparison of two objects, variables, etc. For example, when comparing two objects, it is preferable for programmer to use the equals method rather than ==.

The CollectionChecker contains a set of bug patterns for detecting bugs related to the usage of Collection, e.g., ArrayList, List, Map, etc. For example, if the index of an array is out of its bound, there will be an ArrayIndexOutOfBoundsException.

The ConcurrencyChecker has a set of bug patterns to detect concurrency bugs, e.g., if these is a mismatching between lock( ) and unlock( ) methods, there is a deadlock bug.

The ResourceChecker has a list of bug patterns to detect resource leaking related bugs. For instance, if programmers, or developers, do not close an object of class InputStream, there will be a memory leak bug.

Besides the above-identified five explanation checkers, programmers could also configure other checkers depending on their requirements.

After setting the explanation checkers, the next step is matching the predicted buggy instances with these checkers. In FIG. 16, part 2, also seen as checker matching, shows the matching process. In one embodiment, the system uses these checkers to scan the predicted buggy code snippets. It is determined that there is a match between a buggy code snippet and a checker, if any violations to the checker is reported on the buggy code snippet.

In one embodiment, an output of the explanation checker framework is the matched checkers and the reported violations to these checkers on a given predicted buggy instance. For example, given a source code file or a change, if the system of the disclosure predicts it as buggy (i.e., contains software bugs or security vulnerabilities), the technology will further scan the source code of this predicted buggy instance with explanation checkers. If a checker detects violations, the rules in this checker and violations detected by this checker on this buggy instance will be reported to programmers as the explanation of the predicted buggy instance.

In another embodiment, the method and system of the disclosure may include an ADTree based explanation generator for general defect prediction models with traditional source code metrics. More specifically, a decision tree (ADTree) classifier model is generated or built using history data with general traditional source code metrics. The ADTree classifier assigns each metric a weight and adds up the weights of all metrics of a change. For example, if a change contains a function call sequence, i.e. A->B->C, then it may receive a weight of 0.1 according to the ADTree model. If this sum of weights is over a threshold, the input data (i.e. a source code file, a commit, or a change) is predicted buggy. The disclosure may interprets the predicted buggy instance with metrics that have high weights. In addition, for better presenting the confidence of the generated explanations, the method also shows the X-out-of-Y numbers from ADTree models. X-out-of-Y means Y changes in the training data satisfy a specific rule and X out of them contain real bugs.

For example, if a change is predicted buggy. The generated possible reasons are 1) the change contains 1 or fewer for or 2) the change contains 2 or more lock.

In yet another embodiment, new bug patterns may be used to improve current prediction performance and root cause generation. Examples of new bug patterns may include, but are not limited to, a WrongIncrementerChecker, a RedundantExceptionChecker, an IncorrectMapIteratorChecker, an IncorrectDirectorySlashChecker and an EqualtoSameExpression pattern.

The Wrong IncrementerChecker may also be seen as the incorrect use of index indicator. As programmers use different variables in a loop statement to initialize the loop index and access to an instantiation of a collection class, e.g., List, Set, ArrayList, etc., to fix the bugs detected by this pattern, programmers may use the correct index indicator.

In another example, the RedundantExceptionChecker may be defined as an incorrect class instantiation out of a try block. The programmer may instantiate an object of a class which may throw exceptions outside a try block. In order to fix the bugs detected by this pattern, programmers may move the instantiation into a try block.

The IncorrectmapItertatorChecker can be defined as the incorrect use of method call for Map iteration. The programmer can iterate a Map instantiation by calling the method values( ) rather than the method entrySet( ) In order to fix the bugs detected by this pattern, the programmer should use the correct method entrySet( ) to iterate a Map.

The IncorrectDierctorySlashChecker can be defined as incorrectly handling different dir paths (with or without the ending slash, i.e. “/”). A programmer may create a directory with a path by combining an argument and a constant string, while the argument may end with V″. This leads to creating an unexpected file. To fix the bugs detected by this pattern, the programmer should filter out the unwanted “/” in the argument.

Finally, the EqualToSameExpression can be seen as comparing objects or values from the same method calls with “equals” or “=”. In this example, the programmer compares the same method calls and operands. This leads to unexpected errors by a logical issue. In order to fix the bug detected by this pattern, programmers should use a correct and different method call for one operand.

Note that, the labelling process of security vulnerability prediction is different from defect prediction. For labelling security vulnerability data, vulnerabilities which were recorded in National Vulnerability Database (NVD) are collected. Specifically, all the source of vulnerability reports of a project recorded in NVD are collected. Usually, a vulnerability report contains a bug report recorded in BTS. After a CVE is linked to a bug report, the security vulnerability data can be labelled.

While several embodiments have been provided in the present disclosure, it should be understood that the disclosed systems and methods might be embodied in many other specific forms within departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

What is claimed is:

1. A method of identifying software defects and vulnerabilities comprising:
generating a deep belief network (DBN) based on a set of training code produced by a programmer; and
evaluating performance of a set of test code by against the DBN.

2. The method of claim 1 wherein generating a DBN comprises:
obtaining tokens from the set of training code; and
building a DBN based on the tokens from the set of training code.

3. The method of claim 2 wherein building a DBN further comprises:
building a mapping between integer vectors and the tokens;
converting token vectors from the set of training code into training code integer vectors; and
implementing the DBN via the training code integer vectors.

4. The method of claim 1 wherein evaluating performance comprises:
generating semantic features using the training code integer vectors;
building prediction models from the set of training code; and
evaluating performance of the set of test code versus the semantic features and the prediction models.

5. The method of claim 2 wherein obtaining tokens comprises:
extracting syntactic information from the set of training code.

6. The method of claim 5 wherein extracting syntactic information comprises:
extracting Abstract Syntax Tree (AST) nodes from the set of training code as tokens.

7. The method of claim 1 wherein generating a DBN comprises training the DBN.

8. The method of claim 7 wherein training the DBN comprises:
setting a number of nodes to be equal in each layer;
reconstructing the set of training code; and
normalizing data vectors.

9. The method of claim 8 further comprising, before setting the nodes:
training a set of pre-determined parameters.

10. The method of claim 9 wherein one of the parameters is number of nodes in a hidden layer.

11. The method of claim 2 wherein mapping between integer vectors and the tokens comprises:
performing an edit distance function;
removing data with incorrect labels;
filtering out infrequent nodes; and
collecting bug changes.

12. The method of claim 1 further comprising displaying a report on software defects and vulnerabilities.

13. The method of claim 12 wherein displaying report on software defects and vulnerabilities comprises:
generating an explanation checker framework; and
performing a checker-matching process.

14. The method of claim 13 wherein generating an explanation checker framework comprises:
selecting a set of checkers; and
configuring the set of checkers.

15. The method of claim 14 wherein performing a checker-matching process comprises:
matching determined software defects and vulnerabilities with one of the set of checkers; and
displaying matched checkers; and
reporting software defects and vulnerabilities.

16. The method of claim 14 wherein the set of checkers comprises:
a WrongIncrementerChecker, a RedundantExceptionChecker, an IncorrectMapIteratorChecker, an IncorrectDirectorySlashChecker, and an EqualToSameExpression checker.
